(19) United States
(12) Patent Application Publication
(10) Pub. No.: US 2018/0170129 A1
(43) Pub. Date: Jun. 21, 2018

(54) PNEUMATIC TIRE

(71) Applicant: TOYO TIRE & RUBBER CO., LTD., Itami-shi (JP)

(72) Inventor: Hiroyuki Haseda, Itami-shi (JP)

(73) Assignee: TOYO TIRE & RUBBER CO., LTD., Itami-shi (JP)

(21) Appl. No.: 15/802,629

(22) Filed: Nov. 3, 2017

(30) Foreign Application Priority Data
Dec. 19, 2016 (JP) 2016-245538

(51) Int. Cl. B60C 27/02; B60C 11/03; B60C 11/00

(52) U.S. Cl. CPC B60C 27/0207; B60C 11/0311; B60C 2009/1871; B60C 2011/0313; B60C 11/005

(57) ABSTRACT

A pneumatic tire includes a tread rubber region 5 a belt region 6 including a belt 61 and a contact patch pressure reducing rubber region 7, wherein tread rubber region 5 includes base rubber layer 51 and cap rubber layer 52. The two ends of the tread surface at shoulder lug 55 have first end 551 and a second end (not shown) which is located toward an interior in a tire width direction from first end 551. A contact patch pressure reducing rubber region 7 is disposed at a location between belt 61 and base nibber layer 51. The modulus of contact patch pressure reducing rubber region 7 is lower than the modulus of base rubber layer 51 and is lower than the modulus of cap rubber layer 52.

### TECHNICAL FIELD

The present disclosure relates to a pneumatic tire.

### BACKGROUND ART

At a running pneumatic tire, contact patch pressure at shoulder lugs on the tread surface in the vicinity of the edge of the contact patch being high, the amount of wear at shoulder lugs in the vicinity of the edge of the contact patch is ordinarily greater than at lugs elsewhere on the tread surface.

To prevent such uneven wear, shoulder lugs are sometimes provided with defense grooves. The defense grooves cause shoulder lugs to be divided into main lug portions toward the interior in the tire width direction from the defense groove, and sacrificial lug portions toward the exterior in the tire width direction from the defense groove, as a result of which wear of the main lug portions is suppressed.

However, where defense grooves are provided, there is a possibility that cracking will occur at the bottom of the defense groove and there is a possibility that the sacrificial lug portion will break off therefrom.

### PRIOR ART REFERENCES

### Patent References

PATENT REFERENCE NO. 1: Japanese Patent Application Tokugan No. 2005-10532
PATENT REFERENCE NO. 2: Japanese Patent Application Publication Kokai No. 2008-195099
PATENT REFERENCE NO. 3: Japanese Patent Application Publication Kokai No. 2009-12531

### SUMMARY OF INVENTION

### Problem to be Solved by Invention

It is an object of the present disclosure to, without employment of a defense groove, reduce contact patch pressure in the vicinity of the edge of the contact patch at the shoulder lug, and to improve resistance to uneven wear.

### Means for Solving Problem

A pneumatic tire in accordance with the present disclosure comprises

a tread rubber region comprising a shoulder lug extending in a tire circumferential direction;

a belt region extending in the tire circumferential direction; and

a contact patch pressure reducing rubber region extending in the tire circumferential direction;

wherein the tread rubber region comprises a base rubber layer and a cap rubber layer;

the base rubber layer is disposed at a location toward the exterior in a tire radial direction from the belt region;

the cap rubber layer is disposed at a location toward the exterior in the tire radial direction from the base rubber layer;

the belt region comprises a belt;

the two ends of a tread surface at the shoulder lug consist of a first end and a second end which is located toward the interior in a tire width direction from the first end;

between the belt and a location in the vicinity of the first end at the shoulder lug, the contact patch pressure reducing rubber region is disposed at a location between the belt and the base rubber layer; and

a modulus of the contact patch pressure reducing rubber region is lower than a modulus of the base rubber layer and is lower than a modulus of the cap rubber layer.

In accordance with the present disclosure, causing a contact patch pressure reducing rubber region to be arranged between a belt and a base rubber layer within a region between the belt and a location in the vicinity of a first end at a shoulder lug makes it possible to reduce contact patch pressure in the vicinity of the edge of the contact patch at the shoulder lug and permits improvement in resistance to uneven wear.

It is preferred that the modulus of the base rubber layer be 0.5 MPa to 5 MPa. It is preferred that the modulus of the cap rubber layer be 0.5 MPa to 5 MPa. It is preferred that the modulus of the contact patch pressure reducing rubber region be 0.1 to 0.3 times the modulus at the cap rubber layer.

It is preferred that, the contact patch pressure reducing rubber region comprise a first region disposed at a location toward the exterior in the tire width direction from an imaginary line which extends in the tire radial direction and which passes through the first end at the shoulder lug, and a second region disposed at a location toward the interior in the tire width direction from the imaginary line. It is preferred that the first region extend in the tire width direction and that the thickness thereof decrease with increasing distance from the imaginary line, and that the second region extend in the tire width direction and that the thickness thereof decrease with increasing distance from the imaginary line.

It is preferred that the width in the tire width direction of the contact patch pressure reducing rubber region be 0.1 to 0.5 times the width of the tread surface at the shoulder lug.

It is preferred that the tread rubber region be provided with a major groove extending in the tire circumferential direction at a location toward the interior in the tire width direction from the shoulder lug. It is preferred that the height of the contact patch pressure reducing rubber region along the imaginary line be 0.1 to 0.5 times the depth of the major groove.

It is preferred that the contact patch pressure reducing rubber region have a first face that comes in contact with the belt. It is preferred that the distance between the tread surface at the shoulder lug and the first face of the contact patch pressure reducing rubber region be greater than the depth of the major groove. As viewed in a section in the tire width direction, the intersections of the imaginary line with the outline of the contact patch pressure reducing rubber region may consist of a first intersection, and a second intersection which is disposed at a location toward the interior in the tire radial direction from the first intersection. It is preferred that the distance between the tread surface and the first intersection be greater than the depth of the major groove. Where this is the case, it will be possible to prevent the contact patch pressure reducing rubber region from becoming exposed due to abrasion of the tread rubber region, making it possible for the contact patch pressure reducing rubber region to be made to function right up until the final stage of abrasion.

It is preferred that, the distance between the side face of the tire and the end of the contact patch pressure reducing rubber region which, of the two ends of the first region at the contact patch pressure reducing rubber region, is the farther from the imaginary line be not less than 0.1 times the width of the tread surface at the shoulder lug. Where this is the case, it will be possible in a situation where the side face of the tire becomes damaged to prevent the damage from immediately affecting the contact patch pressure reducing rubber region.

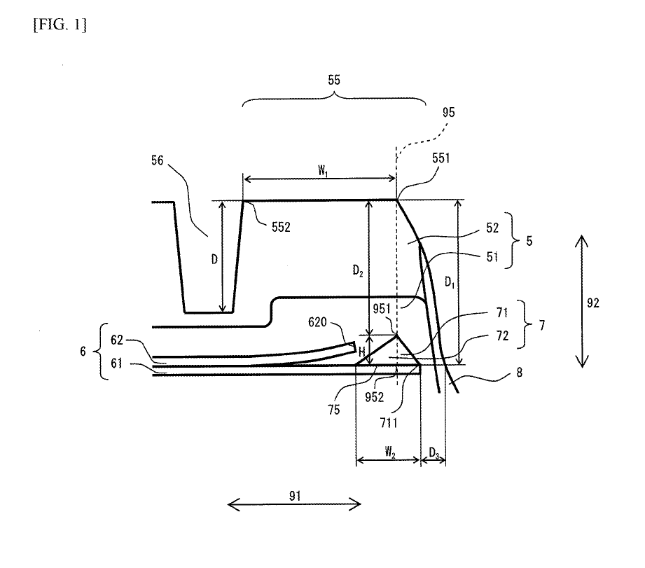

### BRIEF DESCRIPTION OF DRAWINGS

[FIG. 1] Drawing showing section in the tire width direction of a location in the vicinity of a shoulder lug at a pneumatic tire in accordance with a first embodiment.

### EMBODIMENTS FOR CARRYING OUT INVENTION

A first embodiment in accordance with the present disclosure is described below. At FIG. 1, 91 indicates the tire width direction. The tire width direction is the direction which is perpendicular to the equatorial plane of the tire. 92 indicates the tire radial direction. A “section in the tire width direction” is a section cut straight through the pneumatic tire in such fashion as to pass through the two ends of the rotational axis of the tire.

As shown in FIG. 1, a pneumatic tire in accordance with a first embodiment comprises tread rubber region 5, belt region 6, and contact patch pressure reducing rubber region 7. The pneumatic tire of the first embodiment further comprises sidewall rubber region 8.

The pneumatic tire of the first embodiment comprises tread rubber region 5 extending in the tire circumferential direction. Tread rubber region 5 comprises shoulder lug 55 extending in the tire circumferential direction. The two ends of the tread surface at shoulder lug 55 consist of first end 551 and second end 552. Second end 552 is located toward the interior in the tire width direction from first end 551. Width W₁ of the tread surface at shoulder lug 55 might, for example, be 20 mm to 100 mm. Tread rubber region 5 is provided with major groove(s) 56 extending in the tire circumferential direction at location(s) toward the interior in the tire width direction from shoulder lug 55. Depth D of major groove 56 might, for example, be 5.0 mm to 30.0 mm

Tread rubber region 5 is provided with base rubber layer(s) 51 and cap rubber layer(s) 52. Base rubber layer 51 extends in the tire circumferential direction and is disposed at a location toward the exterior in the tire radial direction from belt region 6. The modulus of base rubber layer 51 might, for example, be 0.5 MPa to 5 MPa. Cap rubber layer 52 extends in the tire circumferential direction and is disposed at a location toward the exterior in the tire radial direction from base rubber layer 51. The modulus of cap rubber layer 52 might, for example, be 0.5 MPa to 5 MPa. It is preferred that the modulus of cap rubber layer 52 be greater than the modulus of base rubber layer 51.

The pneumatic tire of the first embodiment comprises belt region 6 extending in the tire circumferential direction. Belt region 6 comprises belt(s) 61. Belt 61 extends in the tire circumferential direction and is disposed at a location toward the exterior in the tire radial direction from a carcass (not shown). Belt region 6 further comprises belt(s) 62. Belt 62 extends in the tire circumferential direction and is disposed at a location toward the exterior in the tire radial direction from belt 61. The width of belt 62 is less than the width of belt 61. As viewed in a section in the tire width direction, the two ends of belt 62 consist of a first end 620 and a second end (not shown). Although belt 62 comes in contact with belt 61, neither of the two ends of belt 62 comes in contact with belt 61. The two ends of belt 62 are disposed at locations toward the exterior in the tire radial direction from belt 61.

The pneumatic tire of the first embodiment comprises contact patch pressure reducing rubber region 7 extending in the tire circumferential direction. Contact patch pressure reducing rubber region 7 is disposed between belt 61 and base rubber layer 51 in the tire radial direction between belt 61 and a location in the vicinity of first end 551 at shoulder lug 55. Being disposed at this location, contact patch pressure reducing rubber region 7 is surrounded by belt 61 and base rubber layer 51. Contact patch pressure reducing rubber region 7 comprises first region 71 disposed at a location toward the exterior in the tire width direction from imaginary line 95 which extends in the tire radial direction and which passes through first end 551 at shoulder lug 55, and second region 72 disposed at a location toward the interior in the tire width direction from imaginary line 95. First region 71 extends in the tire width direction, thickness thereof decreasing with increasing distance from imaginary line 95. Second region 72 extends in the tire width direction, thickness thereof decreasing with increasing distance from imaginary line 95. Width W₂ in the tire width direction of contact patch pressure reducing rubber region 7 might, for example, be 0.1 to 0.5 times width W₁. Height H of contact patch pressure reducing rubber region 7 along imaginary line 95 might, for example, be 0.1 to 0.5 times depth D. Contact patch pressure reducing rubber region 7 has first face 75 which comes in contact with belt 61. Distance D₁ between the tread surface at shoulder lug 55 and first face 75 of contact patch pressure reducing rubber region 7 is greater than depth D. As viewed in a section in the tire width direction, the intersections of imaginary line 95 with the outline of contact patch pressure reducing rubber region 7 consist of first intersection 951, and second intersection 952 which is disposed at a location toward the interior in the tire radial direction from first intersection 951. Distance D₂ between the tread surface and first intersection 951 is greater than depth D. Distance D₃ between the side face of the tire and contact patch pressure reducing rubber region end 711 might, for example, be not less than 0.1 times width W₁. Contact patch pressure reducing rubber region end 711 is the end of first region 71 which, of the two ends thereof, is the farther from imaginary line 95. The modulus of contact patch pressure reducing rubber region 7 is lower than the modulus of base rubber layer 51 and is lower than the modulus of cap rubber layer 52. It is preferred, for example, that the modulus of contact patch pressure reducing rubber region 7 be 0.1 to 0.3 times the modulus at cap rubber layer 52.

The pneumatic tire of the first embodiment comprises sidewall rubber region 8 extending in the tire circumferential direction. Sidewall nibber region 8 extends so as to be directed toward a bead region (not shown) from an end of tread rubber region 5. Sidewall rubber region 8 covers the side face of base rubber layer 51. Sidewall rubber region 8 partially covers the side face at cap rubber layer 52.

The pneumatic tire of the first embodiment may be employed as a pneumatic tire intended for heavy loads.

### WORKING EXAMPLES

Working examples and the like which illustrate the constitution and effect of the present invention in specific terms are described below.

### Working Examples 1-3

A test tire having the configuration shown in FIG. I was fabricated. Width W₁ was 40 mm. Details are shown in TABLE 1.

### Comparative Example 1

Except for the fact that it was not provided with a contact patch pressure reducing rubber region 7, a test tire which was identical to that of Working Example 1 was fabricated.

### Comparative Example 2

Except for the fact that it was provided with a defense groove of depth 15 mm, a test tire which was identical to that of Comparative Example 1 was fabricated.

### Modulus

Modulus was measured in accordance with JIS K 6251:2010. More specifically, vulcanization conditions of 150° and 30 min were employed to prepare a JIS No. 3 specimen, the tensile force which produced an elongation of 100% in the specimen was measured, and the value of this tensile force divided by the initial cross-sectional area of the specimen was calculated.

### Resistance to Uneven Wear

A test tire having a tire size of 295/75 R 22.5 was assembled onto a wheel of rim size 22.5×8.25, and testing was carried out by causing this to be run at 760 kPa air pressure (internal pressure as specified by TRA), 80 km/h speed, and 27.5 kN load (TRA 100% load). The ratio of the amount of wear at the shoulder rib (hereinafter “Sh”) to the amount of wear at the center rib (hereinafter “Ce”) (Sh wear amount/Ce wear amount) is shown at TABLE 1. The closer the ratio to 1.0 the better the resistance to uneven wear.

TABLE 1

| | Comparative | Comparative | Working | Working | Working |
|---|---|---|---|---|---|
| | Example 1 | Example 2 | Example 1 | Example 2 | Example 3 |
| Defense groove | Absent | Present | Absent | Absent | Absent |
| Contact patch pressure reducing | Absent | Absent | Present | Present | Present |
| rubber region 7 | | | | | |
| W₂ (mm) | — | — | 20 | 15 | 15 |
| H (mm) | — | — | 5 | 3 | 4 |
| Modulus at contact patch pressure | — | — | 0.3 | 0.8 | 0.6 |
| reducing rubber region 7 (MPa) | | | | | |
| Modulus at cap rubber layer | 3 | 3 | 3 | 3 | 3 |
| 52 (MPa) | | | | | |
| Modulus at base rubber layer | 2 | 2 | 2 | 2 | 2 |
| 51 (MPa) | | | | | |
| D₁ (mm) | — | — | 16 | 16 | 16 |
| D₂ (mm) | — | — | 11 | 13 | 12 |
| D₃ (mm) | — | — | 12 | 15 | 15 |
| Resistance to uneven wear | 1.4 | 1.2 | 1.0 | 1.1 | 1.1 |

Resistance to uneven wear improved as a result of provision of contact patch pressure reducing rubber region 7. For example, employment of a contact patch pressure reducing rubber region 7 of modulus 0.3 MPa caused improvement in resistance to uneven wear by an amount corresponding to 0.4 point (see Comparative Example 1 and Working Example 1).

1. A pneumatic tire comprising:
a tread rubber region comprising a shoulder lug extending in a tire circumferential direction;
a belt region extending in the tire circumferential direction; and
a contact patch pressure reducing rubber region extending in the tire circumferential direction;
wherein the tread rubber region comprises a base rubber layer and a cap rubber layer;
the base rubber layer is disposed at a location toward the exterior in a tire radial direction from the belt region;
the cap rubber layer is disposed at a location toward the exterior in the tire radial direction from the base rubber layer;
the belt region comprises a belt;
two ends of a tread surface at the shoulder lug consist of a first end and a second end which is located toward the interior in a tire width direction from the first end;
between the belt and a location in the vicinity of the first end at the shoulder lug, the contact patch pressure reducing rubber region is disposed at a location between the belt and the base rubber layer; and
a modulus of the contact patch pressure reducing rubber region is lower than a modulus of the base rubber layer and is lower than a modulus of the cap rubber layer.

2. The pneumatic tire according to claim 1 wherein
the modulus of the base nibber layer is 0.5 MPa to 5 MPa;
the modulus of the cap rubber layer is 0.5 MPa to 5 MPa; and
the modulus of the contact patch pressure reducing rubber region is 0.1 to 0.3 times the modulus at the cap rubber layer.

3. The pneumatic tire according to claim 1 wherein the contact patch pressure reducing rubber region comprises a first region disposed at a location toward the exterior in the tire width direction from an imaginary line which extends in the tire radial direction and which passes through the first end at the shoulder lug, and a second region disposed at a location toward the interior in the tire width direction from the imaginary line.

4. The pneumatic tire according to claim 3 wherein
the first region extends in the tire width direction, thickness thereof decreasing with increasing distance from the imaginary line; and
the second region extends in the tire width direction, thickness thereof decreasing with increasing distance from the imaginary line.

5. The pneumatic tire according to claim 1 wherein a width in the tire width direction of the contact patch pressure reducing rubber region is 0.1 to 0.5 times a width of the tread surface at the shoulder lug.

6. The pneumatic tire according to claim 1 wherein the tread rubber region is provided with a major groove extending in the tire circumferential direction at a location toward the interior in the tire width direction from the shoulder lug.

7. The pneumatic tire according to claim 6 wherein height of the contact patch pressure reducing rubber region along the imaginary line is 0.1 to 0.5 times a depth of the major groove.

8. The pneumatic tire according to claim 1 wherein the contact patch pressure reducing rubber region has a first face that comes in contact with the belt.

9. The pneumatic tire according to claim 8 wherein
a distance between the tread surface at the shoulder lug and the first face of the contact patch pressure reducing rubber region is greater than the depth of the major groove;
as viewed in a section in the tire width direction, intersections of the imaginary line with an outline of the contact patch pressure reducing rubber region consist of a first intersection, and a second intersection which is disposed at a location toward the interior in the tire radial direction from the first intersection; and
a distance between the tread surface and the first intersection is greater than the depth of the major groove.

10. The pneumatic tire according to claim 3 wherein a distance between a side face of the tire and an end of the contact patch pressure reducing rubber region which, of the two ends of the first region at the contact patch pressure reducing rubber region, is the farther from the imaginary line is not less than 0.1 times a width of the tread surface at the shoulder lug.
